(19) United States
(12) Patent Application Publication
(10) Pub. No.: US 2007/0296964 A1
(43) Pub. Date: Dec. 27, 2007

(54) Inspection apparatus

(76) Inventors: Mitsugu Nishimura, Tokyo (JP); Gary L. Burkhardt, Adkins, TX (US); James F. Crane, San Antonio, TX (US); Albert J. Parvin, San Antonio, TX (US)

Correspondence Address: MURAMATSU & ASSOCIATES, Suite 310, 114 Pacifica, Irvine, CA, 92618, US

(21) Appl. No.: 11/474,789

(22) Filed: Jun. 26, 2006

(51) Int. Cl. G01N 21/00

(52) U.S. Cl. 356/241.1; 356/241.4

(57) ABSTRACT

An inspection apparatus performs a visual inspection on inner structural members of a large-scale system from the outside without disassembling the system. The inspection apparatus includes a screw device formed in a tube-like shape which engages with surfaces of internal structural members of the large-scale system while advancing into a narrow pathway of the large-scale system when inserted in the narrow pathway and applied with a rotational force, a video scope having a camera at its end which is inserted in the screw device and protrudes from an end of the screw device to capture images of surfaces of the internal structural members of the large-scale system, and a video monitor for displaying the images from the video scope and controlling a direction of the end of the video scope.

### BACKGROUND OF THE INVENTION

1. Field of the Invention

The present invention relates to an inspection apparatus for performing a visual inspection on inner structural members of a large-scale system from the outside without disassembling the system.

2. Description of the Prior Art

In general, inspections are performed on a large-scale system on a regular basis for precautionary purposes. For example, a steam turbine of a power plant is regularly inspected, where it is disassembled and its blades and nozzles, which are the inner structural members of the steam turbine, are visually inspected. Disassembling and reassembling a large-scale system such as the steam turbine requires a large amount of man power and time, resulting in a large scale project.

Therefore, an inspection device is proposed by Japanese Laid-Open Publication No. 7-218394 (U.S. Pat. No. 5,164,826), where inner structural members of such a large-scale system can be visually inspected without disassembling the large-scale system. In this inspection device, a small automatic carriage device is inserted into steam tubes of the steam turbine, where the automatic carriage device is remotely controlled. A video scope is carried by the automatic carriage device to a narrow pathway such as a nozzle block of the steam turbine. The video scope is then moved forward by the automatic carriage device to inspect a specified inner structural member such as turbine blades.

However, in this inspection device, the automatic carriage device cannot be inserted through pathways that are smaller than the automatic carriage device, thus, a scope of inspection is limited. Namely, although the video scope can be carried into a narrow pathway such as the nozzle block of the steam turbine by the automatic carriage device and further moved forward to inspect a further narrow part, since the range of moving the video scope is limited, the possible range of inspection is limited as well.

It may be possible to insert only the video scope into a narrow pathway of the steam turbine. However, inserting the end of the video scope to the desired location is extremely difficult. When such a narrow pathway has a simple shape, the video scope can be inserted deeply through the narrow pathway. However, when the narrow pathway has a complicated shape or such a pathway to be inserted is divided into two or more branches, inserting the video scope through a selected pathway is extremely difficult if not completely impossible. Therefore, it is not practically possible to sufficiently perform the visual inspection of the inner structural members of a large-scale system without dismantling the system.

### SUMMARY OF THE INVENTION

It is, therefore, an object of the present invention is to provide an inspection apparatus which is capable of performing a visual inspection of the inner structural members of a large-scale system from the outside by selectively inserting a video scope through a narrow pathway, even if a narrow pathway of the large-scale system has a complicated shape.

The above-mentioned object is achieved by the inspection apparatus of the present invention which is able to performing a visual inspection on the inner structural members of a large-scale system from the outside. The inspection apparatus includes a screw device formed in a tube-like shape inserted in a narrow pathway of the large-scale system, where it engages with the surface of the inner structural member while advancing forward through the narrow pathway when the rotational force is applied, a video scope mounting a camera at its end and inserted in the screw device until the end projects from the screw device, where the camera captures the images of the surface of the inner structural member of the large-scale system, and a video monitor for monitoring the images and changing the direction of the end of the video scope.

In another aspect, the inspection apparatus for performing a visual inspection of the inner structural members of a large-scale system from the outside includes a screw device formed in a tube-like shape inserted in a narrow pathway of the large-scale system, where it engages with the surface of the inner structural member while advancing forward through the narrow pathway when a rotational force is applied, a video scope having a camera at its end and inserted in the screw device until its end projects from the screw device where the camera captures the images of the surface of the inner structural member, a screw device driver for applying the rotational force to the screw device and transporting the screw device to the narrow pathway in the direction where the end of the video scope is oriented, and a video monitor for monitoring the images and changing the direction of the end of the video scope.

### BRIEF DESCRIPTION OF THE DRAWINGS

More complete appreciation of the invention and many of the attendant advantages thereof will be readily obtained as the same becomes better understood by reference to the following detailed description when considered in connection with the following drawings.

FIG. 1 is a schematic diagram showing a structure of the inspection apparatus in accordance with the first embodiment of the present invention.

FIG. 2 is a diagram showing an example of structure of the screw device incorporated in the inspection apparatus of the first embodiment of the present invention.

FIG. 3 is a diagram showing an example of movement of the articulating portion at the end of the video scope of the inspection apparatus related to the first embodiment of the present invention.

FIG. 4 is a perspective view of the disassembled steam turbine, which is one example of the large-scale system for performing a visual inspection with the inspection apparatus related to the first embodiment of the present invention.

FIGS. 5(a) and 5(b) are schematic diagrams for explaining an operation method of the present invention when the screw device as well as the video scope of the inspection apparatus in the first embodiment are inserted in the narrow pathway of the steam turbine.

FIG. 6 is a schematic diagram showing a structure of the inspection apparatus in accordance with the second embodiment of the present invention.

FIG. 7 is a diagram showing an example of structure of a screw device driver incorporated in the inspection apparatus of the second embodiment of the present invention.

FIG. 8 is a schematic diagram showing a structure of the inspection apparatus in accordance with the third embodiment of the present invention.

### DETAILED DESCRIPTION OF THE PREFERRED EMBODIMENTS

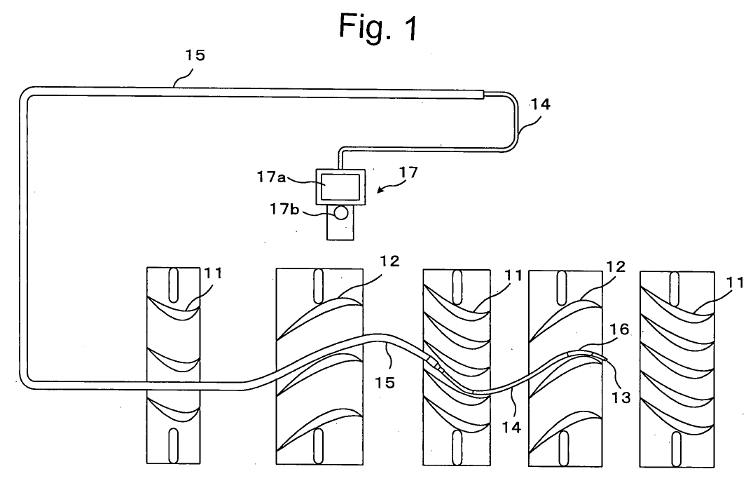

Referring now to the drawings, where like reference numerals designate identical or corresponding components throughout the several views, preferred embodiments of the present invention will be described in detail. FIG. 1 is a schematic diagram showing an example of structure of the inspection apparatus in the first embodiment of the present invention. In FIG. 1, blades and nozzles of a steam turbine are shown as an example of inner structural members of a large-scale system.

The steam turbine introduces the steam generated by a steam generator to blades 11 established on a rotor and to nozzles 12 established on a stator, thereby rotating the rotor to drive an electric power generator. In such a configuration, the passages where the steam passes through the blades 11 and nozzles 12 constitute narrow pathways that to be inspected.

The inspection apparatus of the present invention is configured by a video scope (video probe) 14 having a camera (with a search light) and an articulating portion 16 at its end, and a screw device 15 in which the video scope 14 is inserted for guiding the video scope 14 as it advances forward, and a video monitor 17 for controlling the direction of the end of the video scope 14 as well as displaying the images from the video scope 14.

The video monitor 17 is configured by a display 17a for displaying the images captured by the camera 13, and an operating unit 17b for controlling the direction of the end of the video scope 14. The display 17a of the video monitor 17 is, for example, a liquid crystal display (LCD), and the operating unit 17b of the video monitor 17 is, for example, a joystick.

The articulating portion 16 at the end of the video scope 14 moves in response to the maneuver of the operating unit 17b of the video monitor 17, thereby changing the direction of the end of the video scope 14. The screw device 15 is formed in a tube-like shape, and when it is inserted in the narrow pathway in the steam turbine, and applied with a rotational force, it advances forward through the narrow pathway while engaging with the surfaces of the blades 11 and nozzles 12 within the steam turbine. The video scope 14 moves through the screw device 15 where it is guided through the narrow pathway of the steam turbine until it reaches the area to be inspected.

In other words, the video scope 14 moves through the narrow pathway of the steam turbine while being supported by the screw device 15. Then, the video scope 14 protrudes from the end of the screw device 15, captures the images of the surfaces of the blades 11 and nozzles 12 by the camera 13 mounted at the end of the video scope 14, and sends the captured video signals to the video monitor 17.

Further, the articulating portion 16 at the end of the video scope 14 is driven by the operating unit 17b of the video monitor 17, where the direction of the end of the video scope 14 is changed. By changing the direction of the end of the video scope 14, the images at each orientation of the surfaces of the blades 11 and nozzles 12 can be captured by the camera 13. Moreover, the moving direction of the screw device 15 can be determined by the direction of the end of the video scope 14.

Namely, when the screw device 15 is inserted into the narrow pathway of the steam turbine and applied with the rotational force, it moves through the narrow pathway while contacting with the surfaces of the blades 11 and nozzles 12 within the steam turbine. The moving direction during this operation is determined by the direction of the end of the video scope 14 that is inserted in the narrow pathway.

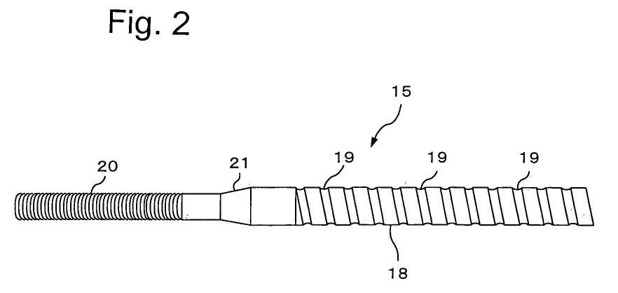

Next, the screw device 15 will be described in detail. FIG. 2 is a partial cut-out view showing an outer shape of the end of the screw device 15. As shown in FIG. 2, a main body 18 is formed in a tube-like shape, and is composed of helical notches 19 on the outside for engaging with the surfaces of the inner structural members. When the rotational force is applied to the main body 18, the helical notches 19 rotate and engage with the surface of the inner structural member. Therefore, a driving force is produced by a frictional force created by contacting the helical notches 19 with the inner structural members, which moves the screw device 15 through the narrow pathway.

An end 20 is formed with a bellows shape or an accordion-like structure and is made of flexible material. For example, the end 20 is formed of an extension spring. The reason that the end 20 is formed of such flexible material is that the end of the video scope 14 to be inserted through the screw device 15 can easily select the moving direction of the screw device 15.

When determining the moving direction of the screw device 15, the video scope 14 takes the lead and the screw device 15 follows the video scope 14. However, there are times when the video scope 14 has to be bent in the direction desired to proceed. Since the force to bend the video scope 14 is small, if the end of the screw device 15 is made of hard material, it will not be able to bend the video scope 14 when it is necessary. For this reason, the end of the screw device 15 is made of flexible material such as a stretchable (extension) spring. Further, the main body 18 and the end 20 are connected by a joint 21. The joint 21 is also made of flexible material such as rubber.

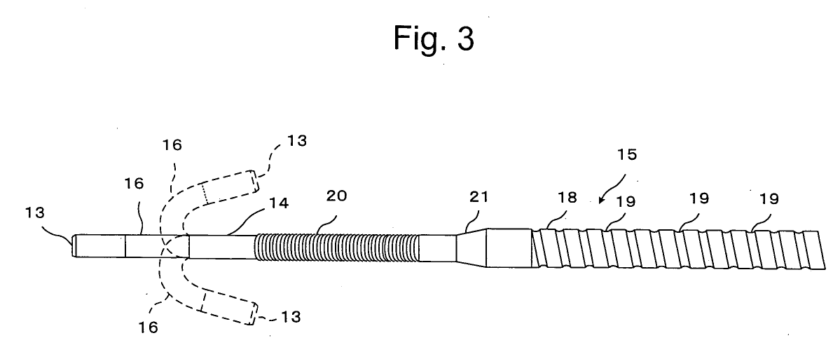

Next, the movement of the articulating portion 16 formed at the end of the video scope 14 will be described in detail. FIG. 3 is a partial cut-out view showing an outer shape of the end of the video scope 14 when protruding from the end of the screw device 15. As shown in FIG. 3, the articulating portion 16 at the end of the video scope 14 is so configured that it can be bent in a flexible manner. In the example of FIG. 3, the articulating portion 16 is bent in the direction opposite to that of the original direction of the end of the video scope 14. However, the end of the video scope 14 can be changed its direction so that it can orient any direction in a three-dimensional space by adjusting the bent direction and bent angle of the articulating portion 16.

The direction of the end of the video scope 14 is changed by driving the articulating portion 16 which is regulated by the operating unit 17b of the video monitor 17 shown in FIG. 1. As a consequence, the direction of the camera 13 established at the end of the video scope 14 can be changed in a wide angle, which also enables to determine the moving direction of the screw device 15.

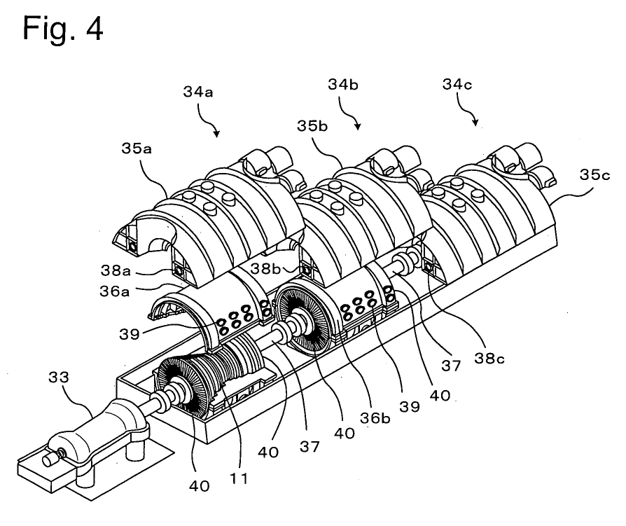

Next, the method of operating the inspection apparatus of the present invention will be described in detail. FIG. 4 is a perspective view of the disassembled steam turbine. In FIG. 4, one high pressure turbine 33, and three low pressure turbines 34a, 34b and 34c are shown. The low pressure turbine 34a is illustrated with a situation where a turbine external room 35a and a turbine internal room 36a removed therefrom, and the low pressure turbine 34b is illustrated with a situation where the turbine external room 35b removed therefrom.

The exterior of each low pressure turbine 34a, 34b, and 34c is covered by turbine external rooms 35a, 35b and 35c, respectively. The turbine external rooms 35a, 35b and 35c are also called external casings, each being structured in the shape of a hollow cylinder. The turbine external rooms 35a, 35b and 35c achieve the function of covering a turbine rotor 37 as well as turbine internal rooms 36a, 36b and 36c, and are individually structured by a top member and a bottom member where the top member is removed during inspection. In FIG. 4, the turbine internal room 36c of the low pressure turbine 34c is not shown in the drawing since it is covered by the turbine external room 35c.

Further, manholes 38a, 38b and 38c are established on a disc surface of the turbine external rooms 35a, 35b and 35c, respectively, in an axial direction. The manholes 38a, 38b and 38c are holes established in the axial direction of the turbine external rooms 35a, 35b and 35c where they are closed during the normal operation. These manholes 38a, 38b, and 38c are holes for looking inside the turbines during inspection without removing the turbine external rooms 35a, 35b and 35c to check the condition up to the final blade.

The turbine internal rooms 36a, 36b and 36c are also called internal casings, and cover the blades 11 and the rotor 37. Similar to the turbine external rooms 35a, 35b and 35c, each of the turbine internal room is constructed by a top member and a bottom member, where several hand holes 39 are established thereon. The hand holes 39 are holes established on the side of each of the turbine internal rooms 36a, 36b and 36c, and similar to the manholes 38a, 38b, and 38c, they are holes for looking inside the turbine internal rooms 36a, 36b and 36c to check the condition inside the turbines as well as the blades and nozzles.

Further, the last turbine 40 of each of the low pressure turbines 34a, 34b and 34c has the longest blade, and the flow of the steam is introduced to the center of each of the low pressure turbines 34a, 34b and 34c the shortest blade is located, where it provides work to the blades 11 on both sides in the axial direction and expands while heading toward the direction of the final turbines 40 on both sides to be exhausted therefrom.

For the above structured steam turbine, when the turbine external rooms 35a, 35b and 35c are removed leaving only the turbine internal rooms 36a, 36b and 36c, the screw device 15 is inserted through the hand holes 39 established on the side of each of the turbine internal rooms 36a, 36b and 36c or through the final turbines 40. On the other hand, when the turbine external rooms 35a, 35b and 35c are assembled to the steam turbine, the screw device 15 is inserted through the manholes 38a, 38b and 38c established in the axial direction of the turbine external rooms 35a, 35b and 35c.

For example, as shown in FIG. 4, when the turbine external room 35c of the low pressure turbine 34c is attached to the steam turbine, first, an inspector opens a lid of the manhole 38c of the steam turbine, and manually inserts the screw device 15 having the video scope 14 therein until it reaches the blade 11 of the steam turbine. Then, the inspector manually sends the video scope 14 so that it projects from the end of the screw device 15. As a result, the camera 13 of the video scope 14 will be positioned close to the blade 11.

In this condition, the inspector checks the images on the display 17a of the video monitor 17 received from the camera showing the areas surrounding the camera 13. The inspector drives the articulating portion 16 through the operating unit 17b to select an area to be inspected. Since the direction of the end of the video scope 14 changes by the movement of the articulating portion 16, the location of the camera 13 changes as well. Accordingly, the inspector can select an area to be inspected while looking at the image on the display 17a of the video monitor 17.

When the area to be inspected is determined, the end of the video scope 14 is directed towards the inspection area by moving the articulating portion 16. Then, the screw device 15 is rotated. When the rotational force is applied to the screw device 15, the helical notches 19 on the main body 18 engage with the surfaces of the blade 11 and nozzle 12, which are the internal structural members. The driving force for moving towards the narrow pathway of the steam turbine is created by the friction created by contacting the helical notches 19 with the blade 11 and nozzle 12. Thus, the screw device 15 moves forward through the narrow pathway while being guided by the end of the video scope 14 that is projected from the end of the screw device 15. As a consequence, the screw device 15 advances in the direction of the end of the video scope 14 toward the inspection area.

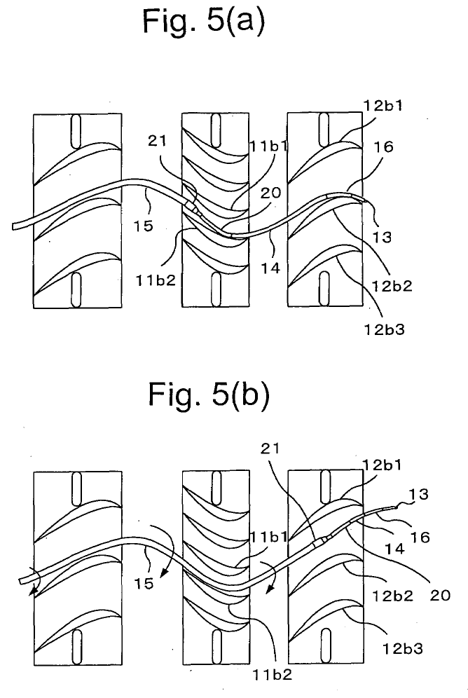

FIGS. 5(a) and 5(b) schematically show the operation method of the present invention when the screw device 15 is inserted into the narrow pathway of the steam turbine. FIG. 5(a) shows the situation where the end of the video scope 14 is located in the narrow pathway located between the nozzles 12b1 and 12b2, and the end 20 of the screw device 15 is located in the narrow pathway located between the blades 11b1 and 11b2.

Under the condition where the end 20 of the screw device 15 is inserted in the narrow pathway located between the blades 11b1 and 11b2, the inspector manually sends the video scope 14 so that it projects from the end 20 of the screw device 15. Then, the inspector determines the area to be inspected while monitoring the images from the camera 13 shown on the display 17a of the video monitor 17.

For example, if the narrow pathway located between the nozzles 12b1 and 12b2 is selected as the area to be inspected, the inspector controls the articulating portion 16 through the operating unit 17b on the video monitor 17 to direct the end of the video scope 14 towards the narrow pathway, and manually sends the video scope 14. As a consequence, the end of the video scope 14 moves into the narrow pathway located between the nozzles 12b1 and 12b2, i.e., the inspection area, as shown in FIG. 5(a).

Then, the inspector manually rotates the screw device 15. When the rotational force is applied to the screw device 15, the helical notches 19 on the main body 18 engages with the surfaces of the blade 11 and nozzle 12. Thus, the driving force is produced in the direction of the end of the video scope 14 by the frictional force created by the engagement with the blade 11 and nozzle 12. Accordingly, the screw device 15 moves closer to the narrow pathway located between the nozzle 12b1 and 12b2, i.e., the inspection area, as shown in FIG. 5(b).

In the situation of FIG. 5(b), in order to further advance into the narrow pathway of the steam turbine, the video scope 14 is further sent in manually so that the end thereof further extends from the end 20 to select an area to be inspected. The articulating portion 16 of the video scope 14 is maneuvered through the operating unit 17b of the video monitor 17 so that the video scope 14 is oriented toward the area to be inspected, and the video scope 14 is manually sent in. Then, the screw device 15 is rotated so that it reaches the area to be inspected.

According to the first embodiment of the present invention, since the video scope 14 is supported by the screw device 15 and can advance in the desired direction while selecting the narrow pathway of the steam turbine to be inspected, it is possible to acquire images of the desired areas to be inspected on the display 17a of the video monitor 17. Therefore, visual inspection of the blade and nozzle, which are the internal structural members, can be conducted without disassembling the steam turbine.

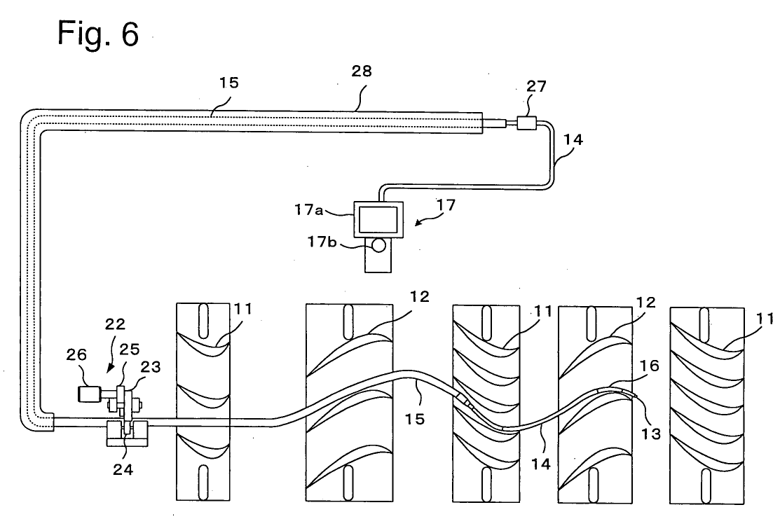

Next, the second embodiment of the present invention will be explained in detail. FIG. 6 shows an example of structure of the inspection apparatus related to the second embodiment of the present invention. The second embodiment is different from the first embodiment shown in FIG. 1 in that it additionally includes a screw device driver 22. The screw device driver 22 applies a rotational force to the screw device 15 and automatically sends out the screw device 15 to the narrow pathway of the large-scale system such as the steam turbine in the direction where the end of the video scope 14 is oriented. In FIG. 6, the reference numerals used in the previous example denote the same components and the description of which is omitted.

The screw device driver 22 is formed of a drive wheel 23, an auxiliary wheel 24, a gear 25, and a drive motor 26 which drives the drive wheel 23 through the gear 25. When the drive wheel 23 is driven through the gear 25 by the drive motor 26, the drive wheel 23 and auxiliary wheel 24, which contact the outer surface of the screw device 15, apply a rotational force to the screw device 15. In other words, the screw device 15 is held between the drive wheel 23 and auxiliary wheel 24, where the rotational force is applied to the screw device 15 by rotating the drive wheel 23. It should be noted that although the screw device 15 rotates, the video scope 14 inserted in the screw device 15 will not rotate.

When the rotational force is applied to the screw device 15 by the screw device driver 22, as mentioned above, the helical notches 19 on the main body 18 contact the surfaces of the blade 11 and nozzle 12, which are the inner structural members. Thus, a driving force for moving the screw device 15 towards the narrow pathway of the steam turbine is generated by the frictional force created by contacting between the helical notches 19 with the blade 11 and nozzle 12. Then, the screw device 15 advances towards the narrow pathway of the steam turbine.

Further, it is also possible to incorporate a video scope driver 27 and a screw device retainer 28 as shown in FIG. 6 if necessary. The video scope driver 27 holds the video scope 14 and sends it through the screw device 15 by manually pressing forward. Moreover, the video scope driver 27 can install a drive motor, where a device for converting the rotational force from the drive motor into a linear motion is provided so that the video scope 14 can be sent out by the linear motion. The screw device retainer 28 holds the screw device 15 at the outside of the steam turbine as well as guides the screw device 15 through the steam turbine.

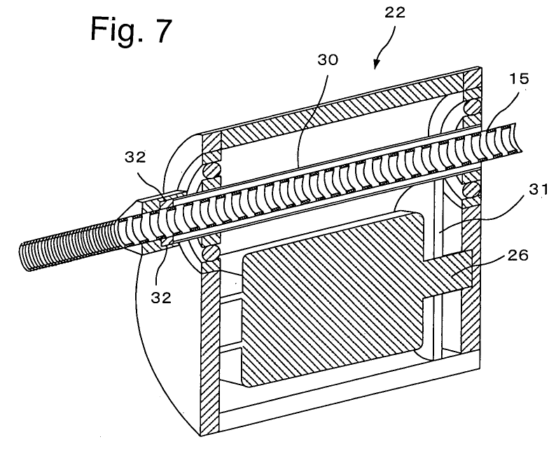

In the foregoing description, the screw device driver 22 holds the screw device 15 between the drive wheel 23 and the auxiliary wheel 24, where the rotational force is applied to the screw device 15 by rotating the drive wheel 23 by the drive motor 26 so that the screw device 15 is sent through the steam turbine. However, it is also possible, as shown in FIG. 7, a portable type screw device driver 22 can be incorporated.

As shown in FIG. 7, the portable type screw device driver 22 is configured by a drive motor 26, where the rotational force from the drive motor 26 is transmitted to a disk 31. A drive shaft 30 is rotated by the rotational force through the disk 31. The drive shaft 30 is a hollow, and the screw device 15 is inserted in the through-hole of the hollow. A retainer 32 is provided at one end of the drive shaft 30 for holding the screw device 15 with light pressure, thereby supporting the screw device 15.

In the condition where the retainer 32 is holding the screw device 15 and the rotational force from the drive motor 26 is applied to the drive shaft 30 through the disk 31, the rotational force is also applied to the screw device 15 that is being held by the retainer 32, thus, the screw device 15 itself begins to rotate. As a result, as explained above, the helical notches 19 on the main body 18 engage with the surfaces of the blade 11 and nozzle 12, which are the inner structural members of the steam turbine, the driving force for moving the screw device 15 towards the narrow pathway of the steam turbine is generated by the frictional force created by the engagement with the surfaces of the blade 11 and nozzle 12.

Here, if the inspector holding the portable type screw device driver 22 moves along the driving force (i.e., in the direction where the driving force becomes relaxed) with the screw device 15, the screw device 15 advances into the narrow part of the steam turbine. Accordingly, the inspector consecutively moves closer to the steam turbine along the advancement of the screw device 15. When the inspector holding the portable type screw device driver 22 reaches close enough to the blade 11, which is the entrance of the steam turbine, the inspector operates the retainer 32 to release the screw device 15, and only the inspector and the screw device driver 22 retreat therefrom. By repeating this procedure, the screw device 15 advances further and deeper into the steam turbine.

According to the second embodiment described above, since the screw device 15 can automatically advance forward by the screw device driver 22 instead of manually moved by the inspector, the inspection work for the internal structural member of the large-scale system is reduced. In addition, in the case where the video scope driver 27 is incorporated, the inspection work is further reduced, since the video scope can automatically move forward as well.

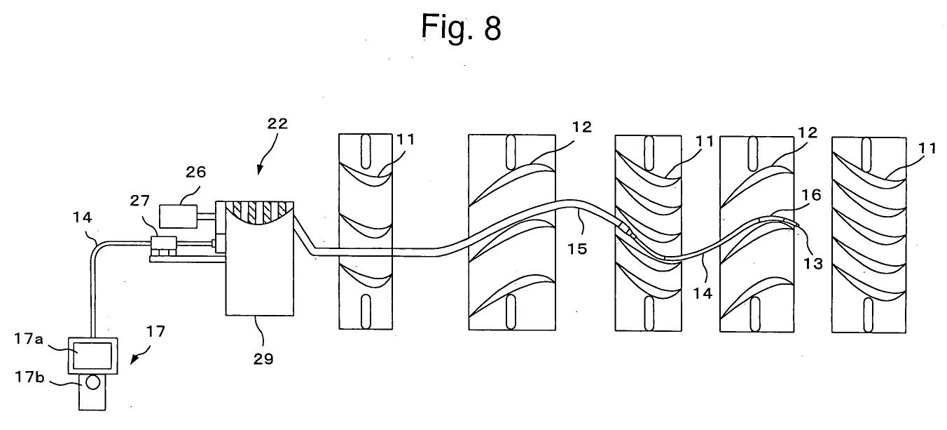

Next, the third embodiment of the present invention will be described in detail. FIG. 8 shows an example of structure of the inspection apparatus related to the third embodiment of the present invention. In the third embodiment, as the screw device driver 22, a rotating drum 29 on which the screw device 15 is wound around and a drive motor 26 for rotating the rotating drum 29 are employed. The rotating drum 29 is rotated by the drive motor 26 to send out or store the screw device 15.

When a rotational force is applied to the rotating drum 29 by the drive motor 26 of the screw device driver 22, which rotates in a forward direction, the screw device 15 that is wound around the rotating drum 29 rotates and comes out from the rotating drum 29, thereby going inside of the steam turbine. As a consequence, as noted above, the helical notches 19 on the main body 18 contact the surfaces of blade 11 and nozzle 12. By the frictional force created by contacting the surfaces of the blade 11 and nozzle 12, a driving force is generated to move the screw device 15 in the direction of the narrow pathway of the steam turbine. Accordingly, the screw device 15 advances in the narrow pathway of the steam turbine. On the other hand, when the drive motor 26 is rotated in a reverse direction, the screw device 15 also rotates in the reverse direction, thereby being extracted from the steam turbine and wound around the rotating drum 29.

Moreover, a video scope driver 27 can be installed if necessary. The video scope driver 27 holds the video scope 14 and sends it through the screw device 15 by pressing the video scope 14 forward. The video scope driver 27 can be formed of a drive motor and a conversion device for converting the rotational force of the drive motor 26 into a linear motion. Thus, the video scope 14 can be automatically sent out by the video scope driver 27.

According to the third embodiment, since the screw device 15 can automatically be sent out by the screw device driver 22 instead of manually moved by the inspector, and the screw device 15 can be wound around the rotating drum 29, storing the screw device 15 is easy and an area at the outside of the steam turbine for the screw device 15 can be reduced.

Obviously, numerous modifications and variations of the present invention are possible in light of the above teachings. It is therefore to be understood that within the scope of the appended claims, the invention may be practiced otherwise than as specifically described herein.

What is claimed is:

1. An inspection apparatus for performing a visual inspection of inner structural members of a large-scale system from outside, comprising:
a screw device formed in a tube-like shape which engages with surfaces of internal structural members of the large-scale system while advancing into a narrow pathway of the large-scale system when inserted in the narrow pathway and applied with a rotational force;
a video scope having a camera at its end which is inserted in the screw device and protrudes from an end of the screw device to capture images of surfaces of the internal structural members of the large-scale system; and
a video monitor for displaying the images from the video scope and controlling a direction of the end of the video scope.

2. An inspection apparatus as defined in claim 1, wherein the screw device is comprised of:
a main body having helical notches for engaging with the surfaces of the inner structural members;
an end that is flexible by having a bellows structure; and
a joint for connecting the main body and the end.

3. An inspection apparatus as defined in claim 1, wherein the large-scale system is a steam turbine, and when an turbine external room is removed leaving only a turbine internal room established on the steam turbine, the screw device is inserted through the narrow pathway of said steam turbine by using either a hand hole established on a side of said turbine internal room or a final blade.

4. An inspection apparatus as defined in claim 1, wherein the large-scale system is a steam turbine, and when a turbine external room is attached to the steam turbine, the screw device is inserted through the narrow pathway of said steam turbine by using a manhole established in an axial direction of said turbine external room.

5. An inspection apparatus for performing a visual inspection of inner structural members of a large-scale system from outside, comprising:
a screw device formed in a tube-like shape which engages with surfaces of internal structural members of the large-scale system while advancing into a narrow pathway of the large-scale system when inserted in the narrow pathway and applied with a rotational force;
a video scope having a camera at its end which is inserted in the screw device and protrudes from an end of the screw device to capture images of surfaces of the internal structural members of the large-scale system;
a screw device driver for applying the rotational force to the screw device to send the screw device through the narrow pathway of the large-scale system in a direction that the end of the video scope is oriented; and
a video monitor for displaying the images from the video scope and controlling the direction of the end of the video scope.

6. An inspection apparatus as defined in claim 5, wherein the screw device driver is comprised of:
a drive wheel that contacts an outer surface of the screw device;
an auxiliary wheel for holding the screw device in combination with the driver wheel; and
a drive motor for driving the drive wheel to apply the rotational force to the screw device through the drive wheel and the auxiliary wheel.

7. An inspection apparatus as defined in claim 5, wherein the screw device driver is comprised of:
a drive shaft for inserting the screw device in a through-hole formed in a hollow thereof;
a retainer established at one end of the drive shaft for holding the screw device inserted in the through-hole; and
a drive motor for applying a rotational force to the drive shaft.

8. An inspection apparatus as defined in claim 5, wherein the screw device driver is comprised of:
a rotating drum on which the screw device is wound around; and
a drive motor for sending out the screw device from the rotating drum by rotating the rotating drum and storing the screw device in the rotating drum.

9. An inspection apparatus as defined in claim 5, wherein the screw device is comprised of:
a main body having helical notches thereon for engaging with the surfaces of the inner structural members;
an end that is flexible by having a bellows structure; and
a joint for connecting the main body and the end.

10. An inspection apparatus as defined in claim 5, wherein the large-scale system is a steam turbine, and when an turbine external room is removed leaving only a turbine internal room established on the steam turbine, the screw device is inserted through the narrow pathway of said steam turbine by using either a hand hole established on a side of said turbine internal room or a final blade.

11. An inspection apparatus as defined in claim 5, wherein the large-scale system is a steam turbine, and when a turbine external room is attached to the steam turbine, the screw device is inserted through the narrow pathway of said steam turbine by using a manhole established in an axial direction of said turbine external room.
